(19) United States
(12) Patent Application Publication
(10) Pub. No.: US 2011/0236193 A1
(43) Pub. Date: Sep. 29, 2011

(54) TURBOCHARGER BEARING LUBRICATION

(75) Inventors: Aaron CHRISS, WOODBURY, CT (US); Thomas SLAIBY, TORRINGTON, CT (US)

(73) Assignee: SCHAEFFLER TECHNOLOGIES GMBH & CO. KG

(21) Appl. No.: 13/052,370

(22) Filed: Mar. 21, 2011

Related U.S. Application Data
(60) Provisional application No. 61/317,551, filed on Mar. 25, 2010.

(51) Int. Cl. F04D 29/063; F04D 29/58; F16C 33/66; F16C 19/04; F04D 29/056

(52) U.S. Cl. 415/180; 384/467

(57) ABSTRACT

A turbocharger assembly includes a turbocharger housing, an elongated cylindrical center housing, a turbine in a turbine housing, a compressor in a compressor housing and a bearing assembly on a rotary shaft. The bearing assembly including balls, ball retainers, an inner and outer ring with raceways thereon, a lubrication port and a cooling port. The cooling port is located towards the outside of the bearing and directed away from the bearing, whereas the lubrication port is directed towards the bearing and is located towards an inside surface of the bearing.

### TECHNICAL FIELD

The present invention relates to improvements in bearings for turbochargers, and, more specifically, improved lubrication and methods of lubrication for bearings for turbochargers.

### BACKGROUND

Turbochargers are well known in the art and are generally used for supplying pressurized air to an internal combustion engine to increase performance. Turbochargers generally comprise a turbine wheel and a compressor wheel on a shared shaft. Bearings, including journal bearings or ball bearings, are used to support the shaft during high speed rotation. The turbine wheel is positioned in a housing shaped to promote passage of exhaust gases from the internal combustion engine over the turbine, in turn causing high speed rotation of the turbine and the associated shaft. This high speed rotation of the shaft then drives the compressor wheel. Generally, the compressor is surrounded by a compressor housing, allowing the rotating compressor to draw in and compress ambient air for subsequent supply to the associated internal combustion engine. The support shaft and bearings are generally housed within a center housing, located between the turbine housing and the compressor housing.

Due to the high rotational speeds of the turbocharger support shaft, considerable effort is placed on maintaining proper operation of the support shaft bearings. For ball bearings, in particular, it is necessary to provide lubrication to the rolling surfaces in order to prevent bearing ring overheating and premature raceway damage. In addition, the high heat of the exhaust gases from the internal combustion engine poses additional problems of thermal transfer to surrounding systems, itself requiring lubrication, often in the form of engine oil, in order to cool the turbocharger system, including the bearings. A further consideration is over-supply of lubricating oil to the bearing, particularly ball bearings, in an effort to address the transient nature of the turbocharger environment. This over-supply may result in reduction of operating efficiency through viscous losses.

Lubrication, once again, often in the form of engine oil, is supplied through ports or “jets” often located in the bearing outer ring or the center housing. The bearing supports are often spaced far apart on the support shaft to maintain low vibration and high rigidity of the system, with the oil supply holes located between the two bearing elements. These oil jets provide oil for both lubrication of the bearing and for cooling of the system.

Generally, cooling demand far exceeds lubrication demand. Volumetric flow within the bearing cavity is controlled by orifice size, input pressure or other restriction methods. In this arrangement, the bearing operates with oil quantity in excess of its optimal value with respect to lubrication function resulting in viscous loss. In addition, all oil used for cooling of the shaft passes through the bearing raceways. Engine oil often contains a level of contamination higher than recommended for proper bearing function, therefore, with the increased volume of possibly contaminated oil passing through the bearing contact zone the probability of indirect damage is high.

Finally, as discussed, numerous configurations and types of bearings have been used to address the issue of reduced friction losses at high speeds, in combination with the thermal transient conditions of a turbocharger operating environment. Increased friction in the support bearings have also been associated with “turbo lag”. “Turbo lag” is generally identified as the delayed response associated with a turbocharger coming to an operating speed wherein pressurized air is effectively supplied to the internal combustion engine and is as a result of the time taken for the exhaust gas driving the turbocharger to come to high enough pressure for the turbine rotor to overcome the rotational inertia of the turbocharger system. Any friction losses, such as due to over-supply of lubricant, may increase this phenomena. Conversely, reduction of friction losses will reduce the time and incidence of “turbo lag”. Reduction of these frictional losses is identified as desirable in the marketplace.

### SUMMARY OF THE INVENTION

The example aspect of the invention described comprises an improved ball assembly for a turbocharger assembly. The turbocharger assembly comprising an outer turbocharger housing, a turbine positioned in a turbine housing with the turbine housing joined with the turbocharger housing by any variety of means, including bolts, with the turbine, in turn, positioned on a rotary shaft. The example embodiment also comprises a compressor positioned on the rotary shaft in a compressor housing, the compressor housing similarly assembled with the turbocharger housing on an opposite end from the turbine housing. Included is a center housing assembled between the compressor housing and the turbine housing, within an inner cavity in the turbocharger housing, and at least two ball bearings positioned towards opposing ends on the rotary shaft between the turbine and the compressor, the ball bearings comprising an outer ring with an outer bearing raceway, a plurality of balls, a ball retainer and an inner ring with an inner bearing raceway. A lubricant reservoir and channel is formed in the turbocharger housing, with at least one bearing lubrication port connected to the reservoir, the port positioned in the center housing between the bearings directed toward lubricating at least one of the bearings and at least one turbocharger cooling port connected to the reservoir, the port positioned in the center housing outside of the bearings, directing lubricant away from the bearings and toward cooling and lubrication of the turbocharger system. The assembly also includes a lubricant exhaust port in the center housing, and a lubricant exhaust port in the outer turbocharger housing to return the lubricant to a central lubricant sump.

A further example embodiment of the invention has the center housing formed as a hollow shaft, forming the bearing outer rings, in which are formed outer bearing raceways. The lubrication and cooling port are positioned through this hollow shaft on opposite ends of each of the bearings.

A further example embodiment of the invention includes having a spacer located between the bearing inner rings. Alternatively, the bearing inner rings may be elongated, extending toward each other and abutting at a point between the two bearings.

### BRIEF DESCRIPTION OF DRAWINGS

The above mentioned and other features and advantages of the embodiments described herein, and the manner of attaining them, will become apparent and be better understood by reference to the following description of at least one example embodiment in conjunction with the accompanying drawings. A brief description of those drawings now follows.

FIG. 1 is a perspective view of a prior art bearing assembly for a turbocharger system.

FIG. 2. is a cross sectional side view of the prior art bearing assembly, taken along line A-A of FIG. 1.

FIG. 3 is a perspective view of the bearing assembly according to an example embodiment of the invention.

FIG. 4 is a cross sectional view of the bearing assembly of FIG. 3, taken along line A-A.

FIG. 5 is a perspective view of the bearing assembly according to a second embodiment of the invention.

FIG. 6 is a cross sectional view of the bearing assembly of FIG. 5, taken along line A-A.

FIG. 7 is a cross sectional view of the bearing assembly according to a third embodiment of the invention.

### DETAILED DESCRIPTION OF THE INVENTION

Identically labeled elements appearing in different ones of the figures refer to the same elements but may not be referenced in the description for all figures. The exemplification set out herein illustrates at least one embodiment, in at least one form, and such exemplification is not to be construed as limiting the scope of the claims in any manner.

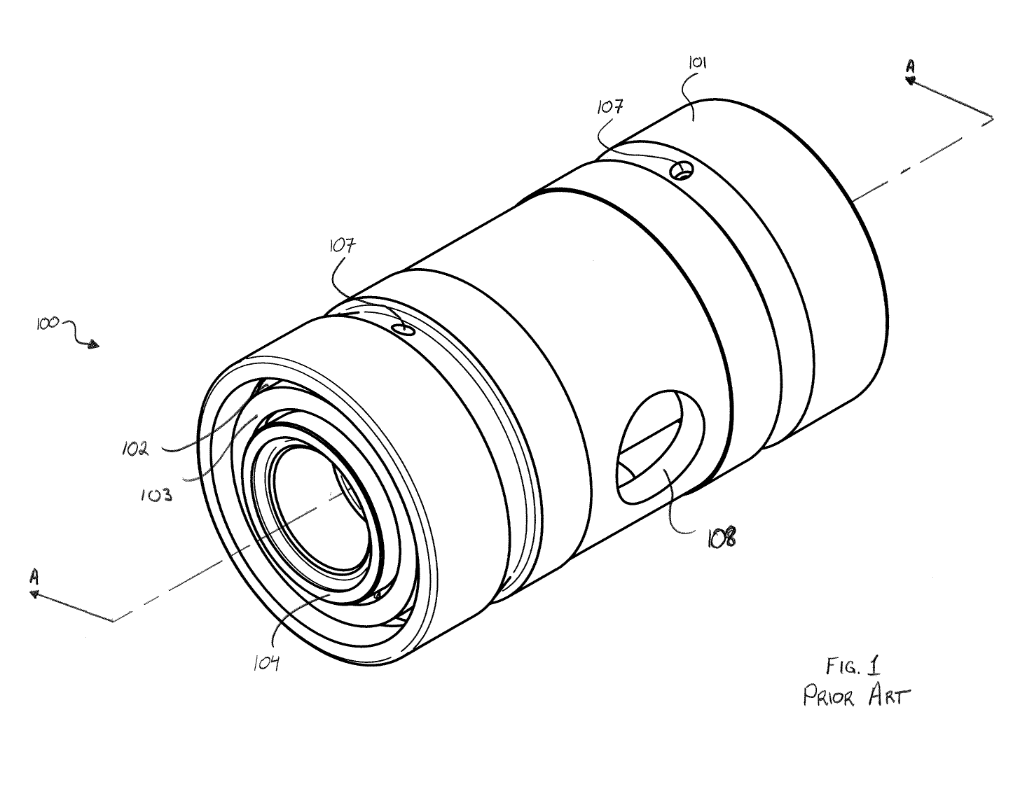

FIG. 1 shows a perspective view of a prior art bearing assembly 100 for a turbocharger (not shown). Bearing assembly 100 comprises a housing 101, shaped as a cylindrical, hollow shaft, and two bearings 102, positioned on opposite ends of the housing. In this example, housing 101 forms the outer ring for bearing 102, bearing 102 also including balls 110, ball retainer or cage 103, inner ring 104, outer raceway 105 in housing 101 and inner raceway 106 in inner ring 104. Inner ring 104 is shown as a cylindrical, hollow ring which, in this example of prior art, would be pressed onto rotary shaft (not shown) of a turbocharger assembly (not shown). Significantly, this prior art shows two lubrication ports 107, which are in communication with an oil channel or reservoir (not shown) in a turbocharger housing (not shown). Lubricant, often in the form of engine oil, is supplied to ports 107, providing enough lubricant into bearing assembly 100 to lubricate bearing 102 and cool the turbocharger assembly. Lubricant enters through ports 107 in close proximity to bearings 102, causing lubricant to flow through bearing 102. Also shown is lubricant exhaust port 108, through which the lubricant supplied through ports 107 is allowed to exit the assembly and return to an external sump (not shown).

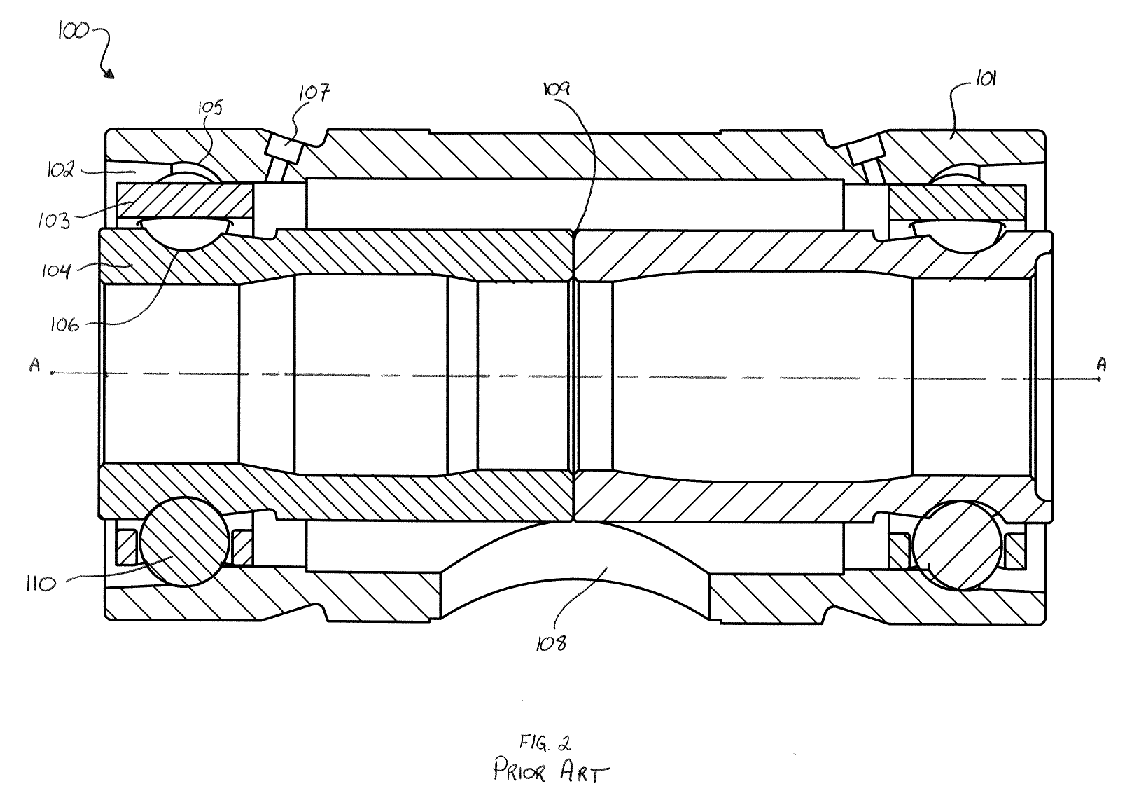

FIG. 2 shows a cross-sectional view of FIG. 1 taken through line A-A, showing in greater detail the components described in FIG. 1. Bearing 102 comprises housing 101, also functioning as a bearing outer ring, balls 110, retainer 103, inner ring 104, outer raceway 105 integrally formed in housing 101 and inner raceway 106 integrally formed in inner ring 104. Inner ring 104 extends from each bearing inwardly to abut the other inner ring, in this case at a central abutment surface 109 within assembly 100. Lubrication ports 107, which may also be positioned on the opposite end of each of bearings 102, is angled toward and in close proximity with bearing 102, providing lubricant in sufficient volume to both lubricate bearing 102 and cool the surrounding turbocharger assembly (not shown). As lubricant completely circulates through the rotating system, it is allowed to exit through lubricant exhaust port 108, which, in turn, is in communication with an lubricant channel, allowing lubricant to return to a central sump or reservoir (not shown).

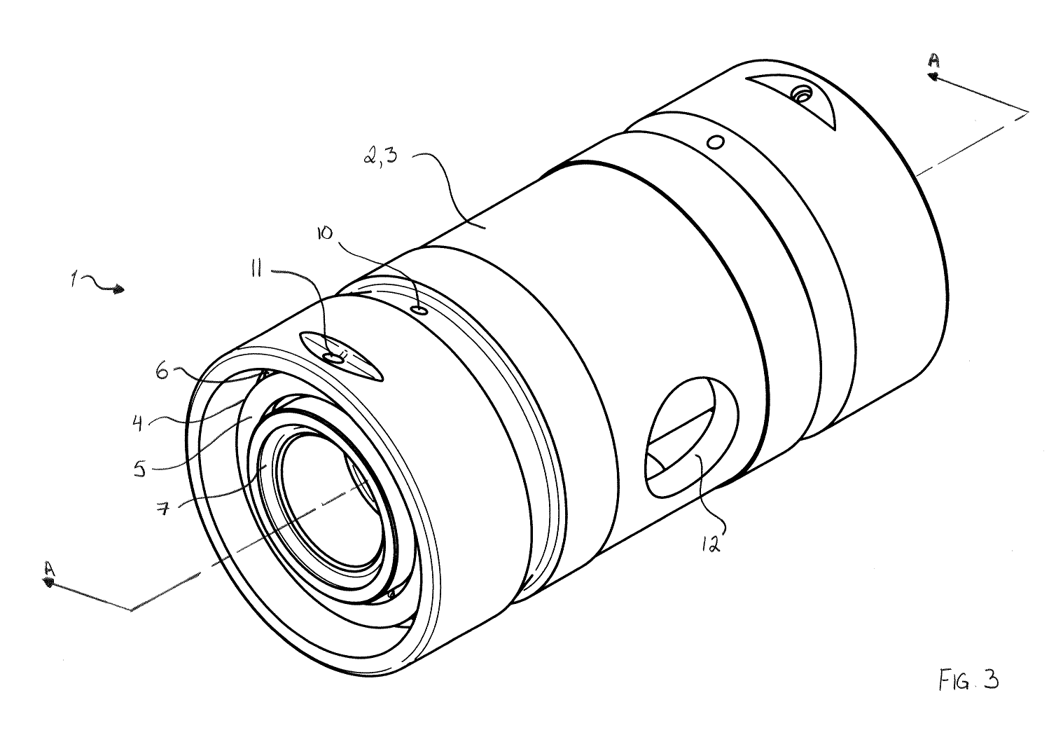

FIG. 3 shows a perspective view of bearing assembly 1 according to an example embodiment of the present invention. Bearing assembly 1 comprises housing 2, shaped as a cylindrical, hollow shaft and also functioning as bearing outer ring 3, at least two bearings 4 positioned on opposite ends of housing 2. Bearings 4 comprise an outer ring 3, in this example formed by housing 2, ball retainer 5, a plurality of balls 6, inner ring 7, here formed as a cylindrical, hollow ring, outer raceway 8 in outer ring 3 and inner raceway 9 in inner ring 7. Housing 2 has at least one lubricant port 10 positioned through housing 2 and in close proximity to an inside surface of at least one of bearings 4, directing lubricant towards bearing 4. At least one cooling port 11 is located towards an outer edge of housing 2 and towards and directed away from bearing 4. Also shown is lubricant exhaust port 12, allowing lubricant entering assembly 1, to exit and return to a central sump (not shown).

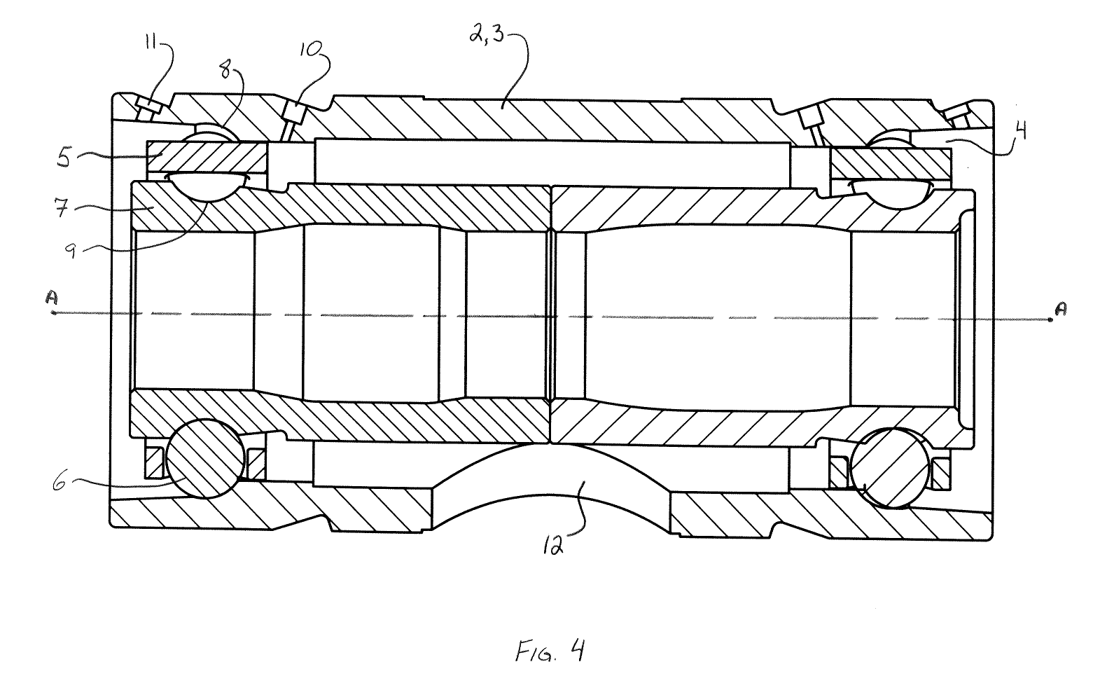

FIG. 4 shows a cross sectional view of bearing assembly 1 of FIG. 3, taken through line A-A. Bearing assembly 1 comprises housing 2, shaped as a cylindrical, hollow shaft and also functioning as bearing outer ring 3, at least two bearings 4 positioned on opposite ends of housing 2. Bearings 4 comprise an outer ring 3, in this example formed by housing 2, retainer 5, a plurality of balls 6, inner ring 7, here formed as a cylindrical, hollow ring, outer raceway 8 in outer ring 3 and inner raceway 9 in inner ring 7. Lubricant port 10 is shown in greater detail, located towards the inside and in close proximity with bearing 4, angled toward balls 6, such that lubricant may enter hearing 4 and provide lubrication between balls 6, outer raceway 8 and inner raceway 9, respectively. On the opposite end of bearing 4 is at least one cooling port 11, angled away from hearing 4 and balls 6, and providing sufficient distance such that lubricant entering through cooling port 11 is directed away from bearing 4 and provided to cool the surrounding turbocharger assembly (not shown). Also shown is lubricant exhaust port 12.

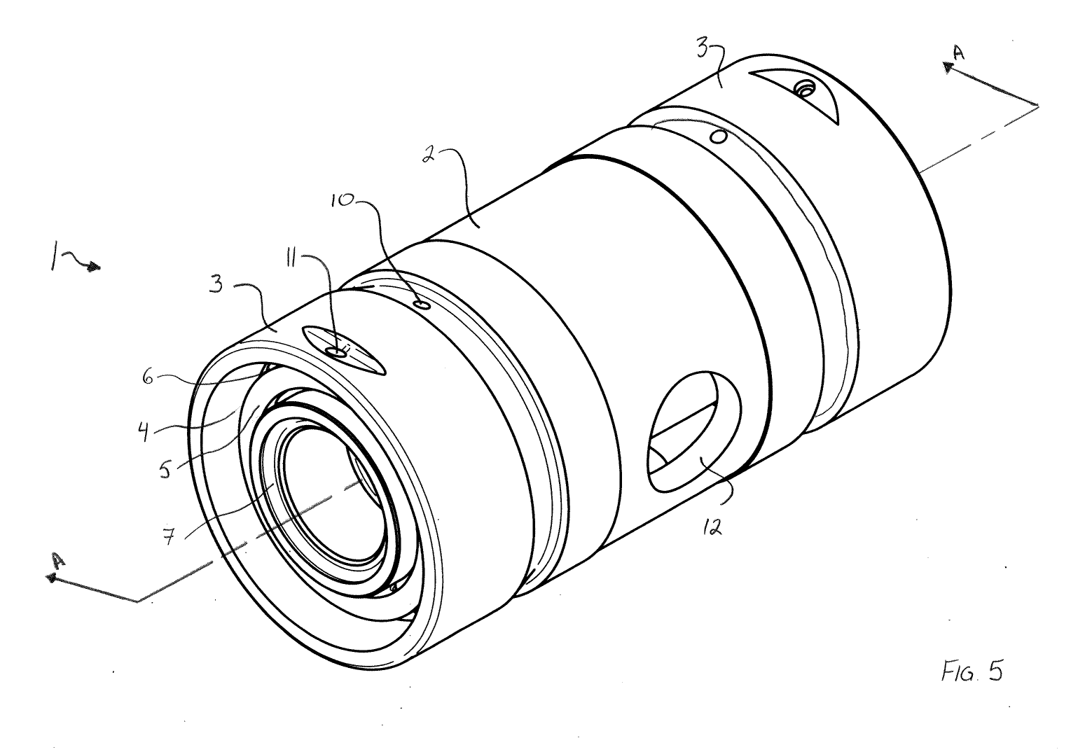

FIG. 5 shows a perspective view of a further example embodiment of bearing assembly 1 of the present invention. In this example embodiment, bearing 4 comprises an outer ring 3 formed separately from housing 2, housing 2 acting also acting as a spacer for bearings 4. The other features of FIG. 5 are the same as previous example embodiments.

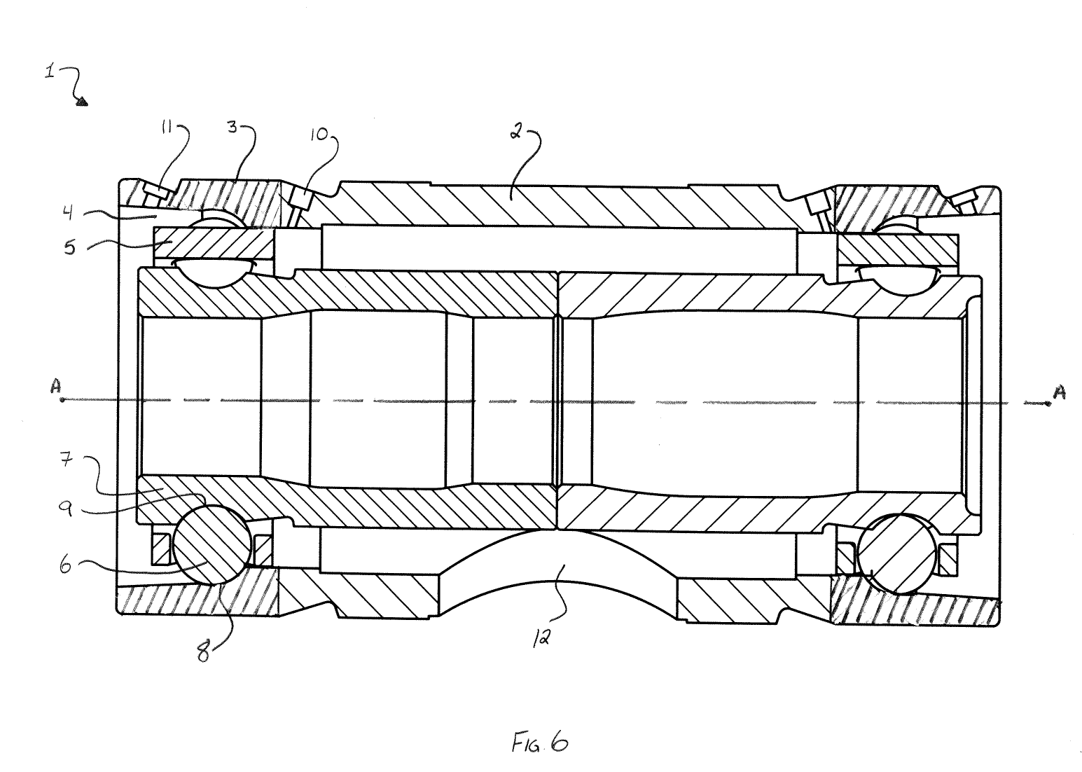

FIG. 6 is a cross sectional view of bearing assembly 1 of FIG. 5, taken along line A-A. As in FIG. 5, bearing 4 is shown having a separate outer ring 3, and housing 2 also acting as a spacer for bearings 4. Although lubricant port 10 is shown as formed through housing 2, bearing outer ring 3 may be elongated to allow lubricant port 10 to be formed through outer ring 3 rather than housing 2. The other components of FIG. 6 are the same as described in FIG. 4, above.

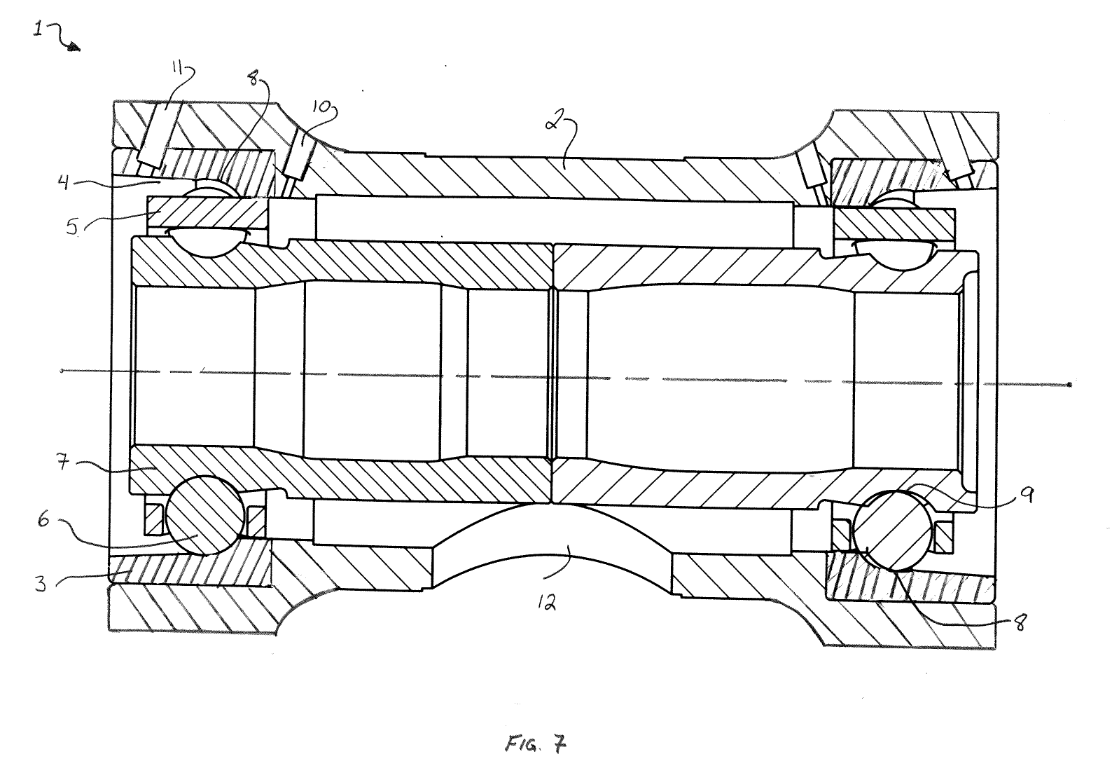

FIG. 7 shows a cross sectional view of third example embodiment of bearing assembly 1 of the present invention. In this example embodiment, outer ring 3 is pressed into housing 2, rather than only abutting housing 2, and ports 10 and 11 are necessarily formed through housing 2 in order to lubricate bearing assembly 1 and cool the turbocharger assembly (not shown), respectively. The remaining components of FIG. 7 are the same as shown in FIG. 6, above.

In the foregoing description, example embodiments are described. The specification and drawings are accordingly to be regarded in an illustrative rather than in a restrictive sense. It will, however, be evident that various modifications and changes may be made thereto, without departing from the broader spirit and scope of the present invention.

In addition, it should be understood that the figures illustrated in the attachments, which highlight the functionality and advantages of the example embodiments, are presented for example purposes only. The architecture or construction of example embodiments described herein is sufficiently flexible and configurable, such that it may be utilized (and navigated) in ways other than that shown in the accompanying figures.

Although example embodiments have been described herein, many additional modifications and variations would be apparent to those skilled in the art. It is therefore to be understood that this invention may be practiced otherwise than as specifically described. Thus, the present example embodiments should be considered in all respects as illustrative and not restrictive.

What we claim is:

1. A turbocharger assembly comprising:
an outer turbocharger housing,
a turbine positioned in a turbine housing, the turbine housing assembled with the turbocharger housing, with the turbine positioned on a rotary shaft,
a compressor positioned on the rotary shaft in a compressor housing, the compressor housing assembled with the turbocharger housing on an opposite end from the turbine housing,
a center housing assembled between the compressor housing and the turbine housing, within an inner cavity in the turbocharger housing,
at least two ball bearings positioned towards opposing ends on the rotary shaft between the turbine and the compressor, the ball bearings comprising an outer ring with an outer bearing raceway, a plurality of balls, a ball retainer and an inner ring with an inner bearing raceway,
a lubricant reservoir and channel in the turbocharger housing,
at least one bearing lubrication port connected to the reservoir, the port positioned in the center housing between the bearings, directed toward lubricating at least one of the bearings;
at least one turbocharger cooling port connected to the reservoir, the port positioned in the center housing outside of the bearings, directing lubricant away from the bearings and toward cooling and lubrication of the turbocharger system,
a lubricant exhaust port in the center housing, and
a lubricant exhaust port in the outer turbocharger housing to return the lubricant to a central lubricant sump.

2. The turbocharger assembly of claim 1, wherein, the bearings are positioned inside the center housing.

3. The turbocharger assembly of claim 1, wherein, the bearings are positioned adjacent and at opposite ends of the center housing.

4. The turbocharger assembly of claim 1, wherein, the at least one bearing lubrication port is positioned through the bearing outer ring, towards the interior surface of the bearing, directed toward the plurality of balls.

5. The turbocharger assembly of claim 1, wherein, the bearing outer ring is elongated.

6. The turbocharger assembly of claim 1, wherein, the center housing forms the bearing outer ring and the bearing outer raceway is formed in the center housing.

7. The turbocharger assembly of claim 1, wherein, the bearing inner raceway is formed into the rotary shaft.

8. The turbocharger assembly of claim 1, wherein, the bearing inner ring is elongated, the at least two bearings' inner rings extending and abutting each other at an interior surface.

9. The turbocharger assembly of claim 1, wherein, the turbocharger housing and the center housing are one part.

10. The turbocharger assembly of claim 5, wherein, the at least one turbocharger cooling port is positioned through the bearing outer ring and the lubricant from that port is directed away from the bearing.

11. A turbocharger assembly comprising:
an outer turbocharger housing,
a turbine positioned in a turbine housing, the turbine housing assembled with the turbocharger housing, with the turbine positioned on a rotary shaft,
a compressor positioned on the rotary shaft in a compressor housing, the compressor housing assembled with the turbocharger housing on an opposite end from the turbine housing,
a center housing assembled between the compressor housing and the turbine housing, within an inner cavity in the turbocharger housing,
at least two ball hearings positioned towards opposing ends on the rotary shaft between the turbine and the compressor, the bearings comprising an outer ring formed from the center housing with an outer bearing raceway formed therein, a plurality of balls, a ball retainer and an inner ring with an inner bearing raceway,
a lubricant reservoir and channel in the turbocharger housing,
at least one bearing lubrication port connected to the reservoir, the port positioned in the center housing between the bearings, directed toward lubricating at least one of the bearings;
at least one turbocharger cooling port connected to the reservoir, the port positioned in the center housing outside of the bearings, directing lubricant away from the bearings and toward cooling and lubrication of the turbocharger system,
a lubricant exhaust port in the center housing, and
a lubricant exhaust port in the outer turbocharger housing to return the lubricant to a central lubricant sump.

12. The turbocharger assembly of claim 11, wherein, the bearing inner ring is elongated, the at least two bearings' inner rings extending and abutting each other at an interior surface.

13. A bearing assembly for a turbocharger system, comprising:
a cylindrical, hollow shaft,
at least two ball bearings positioned towards opposing ends on a rotary shaft, the bearings comprising an outer ring formed from the hollow shaft with an outer bearing raceway formed therein, a plurality of balls, a ball retainer and an inner ring with an inner bearing raceway,
at least one bearing lubrication port, the port positioned in the hollow shaft between the bearings, directed toward lubricating at least one of the bearings;
at least one cooling port connected to the reservoir, the port positioned in the hollow shaft outside of the bearings, directing lubricant away from the hearings and toward cooling and lubrication of the turbocharger system, and
a lubricant exhaust port positioned through a bottom surface of the hollow shaft.

14. A bearing assembly for a turbocharger system, comprising:
a cylindrical, hollow shaft,
at least two ball bearings fixedly positioned towards opposing ends within the hollow shaft, assembled onto a rotary shaft, the ball bearings comprising an outer ring with an outer bearing raceway, a plurality of balls, a ball retainer and an inner ring with an inner bearing raceway,
a spacer located between the at least two bearings,
at least one bearing lubrication port, the port positioned in the hollow shaft between the bearings, directed toward lubricating at least one of the bearings;
at least one cooling port connected to the reservoir, the port positioned in the hollow shaft outside of the hearings, directing lubricant away from the hearings and toward cooling and lubrication of the turbocharger system, and
a lubricant exhaust port positioned through a bottom surface of the hollow shaft.

15. The bearing assembly of claim 14, wherein, at least one of the bearing inner rings is elongated, extending inwardly and abutting the inner raceway of the other bearing.

16. The bearing assembly of claim 14, wherein, the at least two bearing outer rings are elongated, the at least one lubrication port and cooling port being formed through the elongated outer rings, directed toward lubricating the bearing and directed away from the bearing, respectively.

17. The bearing assembly of claim 14, wherein, the bearing inner raceway is formed in the rotary shaft.
